(19) United States
(12) Patent Application Publication
(10) Pub. No.: US 2024/0108440 A1
(43) Pub. Date: Apr. 4, 2024

(54) LOWER ARCH EXPANSION

(71) Applicant: Align Technology, Inc., San Jose, CA (US)

(72) Inventors: Jeremy RILEY, Mountain View, CA (US); Jun SATO, San Jose, CA (US); Mitra DERAKHSHAN, Herndon, VA (US); Chunhua LI, Cupertino, CA (US); Ryan KIMURA, San Jose, CA (US); Siyi LIU, Plano, TX (US); Damin XIA, Nashville, TN (US); Kangning SU, Pullman, WA (US); Somesh PERI, Union City, CA (US); Yuxiang WANG, Newark, CA (US)

(21) Appl. No.: 18/478,975

(22) Filed: Sep. 29, 2023

Related U.S. Application Data
(60) Provisional application No. 63/412,349, filed on Sep. 30, 2022.

(51) Int. Cl. A61C 7/10; A61C 7/00; A61C 7/08

(52) U.S. Cl. CPC A61C 7/10; A61C 7/002; A61C 7/08

(57) ABSTRACT

Dental appliances and methods for expanding the lower dental arch. The appliances may be removable mandibular expander devices for efficient arch expansion while being comfortable to wear and easy to use. The appliances may include a lingual portion that is shaped and sized to apply an expansion force to lingual surfaces of one or more teeth. The shape and size of the lingual portion may be configured to distribute the forces among posterior and/or anterior teeth. A series of expander devices may be designed to provide the expansion forces in a stepwise fashion toward a target lower arch configuration according to a treatment plan

### CLAIM OF PRIORITY

This patent application claims priority to U.S. Provisional Patent Application No. 63/412,349, titled “APPARATUSES FOR LOWER ARCH EXPANSION,” filed on Sep. 30, 2022, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

Dental arch expansion devices are used to widen a narrow jaw. These devices may be used to correct or prevent overcrowding of teeth, correct malocclusions and/or treat sleep disordered breathing. Devices for expanding the upper jaw (maxilla) are generally referred to as palatal expanders since they are designed to expand a narrow palate. In some cases, the teeth of the lower jaw may alternatively or additionally be expanded using a lower arch expander. The upper and/or lower arch expanders may be used to correctly align the upper and lower teeth or arches when the jaws are closed together in a bite.

Traditionally, arch expansion devices include a screw or other mechanism to deliver a horizontal force to the posterior teeth (e.g., molars, pre-molars, etc.) to stretch the cartilage and/or move the molars outward. In many cases, a large horizontal force is delivered by the orthodontist upon placement. This can cause extreme discomfort including headaches, nasal discomfort and pain. In other cases, the screw or other mechanism is employed to incrementally adjusted one or more times a day. While this incremental approach may ease some of the discomfort, the incidence of discomfort remains high. Moreover, the devices are awkward and bulky, largely due to the expansion mechanism. This bulkiness can cause difficulty with speech, swallowing and breathing. The screw or other mechanism can be difficult to operate and often involves use of a key which can be accidentally lost or swallowed. In addition, the screw or other expansion mechanism tend to have many crevices where plaque may accumulate.

Thus, there is a need for lower arch expansion apparatuses that may address these, and other problems associated with traditional arch expansion devices.

### SUMMARY

Described herein are expander appliances that may be part of a series of ordered expanders to incrementally expand the lower arch. For example, the apparatuses (e.g., devices and systems) and methods described herein may relate to orthodontic treatment plans that involve expanding the width and/or length of the lower dental arch. A treatment plan may include the use of one or a series of removable lower arch (e.g., mandibular) expander devices that are designed for efficient arch expansion while being reasonably comfortable to wear and easy to use. The expander apparatuses may be configured to apply a customized force distribution on the teeth in an outward direction to expand the width and/or length of the lower arch. A series of expander devices may be designed to provide the customized forces in a stepwise fashion toward a target lower arch width and/or length according to an orthodontic treatment plan.

In general, described herein are systems for expanding a patient's lower dental arch. These lower arch expanders may be referred to as mandibular expanders, mandibular expansion apparatuses, mandibular expansion systems, mandibular expansion devices, lower arch expansion apparatuses, lower arch expansion devices and/or lower arch expansion systems. Systems including mandibular expanders may include a series of mandibular expansion appliances, including polymeric shells configured to apply an expansion force for widening (and in some examples, lengthening) the patient's mandibular arch. The series of appliances may have progressively larger expansion widths (and in some examples, progressively larger expansion lengths. For example, the expansion width of each sequential appliance in the series may be the same or larger and may generally increase over the series of appliances. Thus, described herein are individual appliances that are configured to apply an expansion (and in some examples, lengthening) force for mandibular (lower jaw) expansion; any of these appliances may be arranged as part of a series of appliances that are configured to be worn in sequential order to expand (and in some cases lengthen) the lower arch.

For example, described herein are systems for expanding a patient's lower dental arch that include: a series of expander devices each configured to incrementally expand the patient's lower dental arch toward a desired arch configuration based on a treatment plan, wherein each expander device of the series of expander devices comprises a polymeric shell comprising: a first tooth-receiving portion shaped to receive one or more first teeth, the first tooth-receiving portion having a first lingual side, a first buccal side and a first occlusal side; a second tooth-receiving portion shaped to receive one or more second teeth, the second tooth-receiving portion having a second lingual side, a second buccal side and a second occlusal side; and a bridge region coupling the first lingual side to the second lingual side, wherein the bridge region is configured to maintain an expansion width between the first lingual side and the second lingual side that applies an expansion force between the one or more first teeth and the one or more second teeth when the device is worn on a patient's lower dental arch to expand the patient's lower dental arch, wherein the first lingual side and the second lingual side are configured to receive the expansion force and to apply it to the teeth, further wherein the expansion widths of the expander devices in the series of expander devices increase over a course of the series. In some examples, the first and second lingual sides are stiffer than the first and second buccal sides or the first and second occlusal sides. For example, the first and second lingual sides may be thicker than the first and second occlusal sides or the first and second buccal sides.

As used herein, the phrase “expansion width” may refer to the target width(s) to which the lower jaw is to be expanded to incrementally over a treatment. The expansion width may refer to the width between the molars and/or premolars and/or canines on opposite sides of the patient's lower jaw. The expansion width may be estimated as part of a treatment plan.

In any of these systems and devices, the polymeric shell of each expander device may be made of a single polymer material. The single polymer may be treated to increase or decrease stiffness in the regions described herein (e.g., increasing stiffness of the lingual regions).

In general, each of these apparatuses may be generally U-shaped, so that there is a passage or opening between the first and second lingual sides for the patient's tongue to comfortably reside.

The width between the first lingual side and the second lingual side of each subsequent expander device of the series of expander devices is wider than a previous expander device in the series. In particular, the width between the first lingual side and the second lingual side may be an expansion width (or a portion of the total expansion width) to which the lower jaw is to be expanded. The expansion width may be greater in more distal (back of the mouth) regions as compared to more anterior (front of the mouth) regions. For example, the change in the width of the lower jaw caused by the expansion width may be greater in the more distal (e.g., molars) regions as compared to more proximal (e.g., pre-molars, canines, incisors) regions/teeth. In some examples the change in the width of the lower jaw caused by the expansion width may be the same between the premolars and molars.

Each expander device of the series of expander devices may be configured to apply the expansion forces with a magnitude and direction in accordance with a stage of an arch expansion treatment plan.

The expansion force of each expander device of the series of expander devices may be between about 1 Newton (N) and about 25 N when the device is worn on the teeth. The bridge region of at least one of the expander devices of the series of expander devices may be configured to contact one or more anterior teeth when the device is worn on the patient's lower dental arch. For example, the bridge region of at least one of the expander devices of the series of expander devices may be configured to apply a second expansion force on the one or more anterior teeth. The second expansion force may be between about 1 Newton (N) and about 5 N, but not limited to.

In any of these apparatuses, the bridge region may be configured to conform to a lingual surface of the patient's lower dental arch when the device is worn by the patient. For example, the bridge region may be configured to conform to a lingual surface of one or more anterior teeth when the device is worn by the patient.

The first lingual side may be thicker than the first buccal side, and the second lingual side may be thicker than the second buccal side for all or some of the expander devices of the series of expander devices. For example, the first lingual side may be about 5% or more, 10% or more, 15% or more, 20% or more, 25% or more, 30% or more, 35% or more, 40% or more, 45% or more, 50% or more, 55% or more, 60% or more, 70% or more, 75% or more, etc. thicker than the first buccal side; likewise the second lingual side may be about 5% or more, 10% or more, 15% or more, 20% or more, 25% or more, 30% or more, 35% or more, 40% or more, 45% or more, 50% or more, 55% or more, 60% or more, 70% or more, 75% or more, etc. thicker than the second buccal side.

The first tooth-receiving portion and the second tooth-receiving portion for each of the expander devices of the series of expander devices may be shaped to receive only molars, premolars, or molars and premolars and/or include canines. The first tooth-receiving portion and the second tooth-receiving portion for at least one of the expander devices of the series of expander devices may include one or more openings that are arranged to allow exfoliation of one or more primary teeth of the patient's lower dental arch. One or both of the first tooth-receiving portion and the second tooth-receiving portion for each of the expander devices of the series of expander devices may comprise one or more bite adjustment structures that are configured to promote mandibular advancement, wherein the one or more bite adjustment structures are shaped and arranged to contact the patient's upper dental arch or a dental device on the patient's upper dental arch.

The one or more bite adjustment structures may be shaped and arranged to contact corresponding one or more bite adjustment structures of the dental device on the patient's upper dental arch. One or both of the first occlusal side and the second occlusal side for at least one of the expander devices of the series of expander devices may have a thickness configured to disocclude anterior teeth and/or posterior teeth of the patient's lower dental arch. Also described herein are systems for expanding a patient's lower dental arch that include: a series of expander devices each configured to incrementally expand the patient's lower dental arch toward a desired arch configuration based on a treatment plan, wherein each expander device of the series of expander devices comprises a polymer shell comprising: at least one tooth-receiving portion shaped to receive one or more first teeth of a first side of a patient's lower dental arch, the at least one tooth-receiving portion including a buccal side and an occlusal side; a lingual portion coupled to the at least one tooth-receiving portion and arranged to contact lingual surfaces of one or more second teeth on an opposite side of the patient's lower dental arch when the device is worn on the patient's lower dental arch; and a bridge portion shaped and sized to transmit an arch expanding force to the lingual portion in accordance with a corresponding stage of the treatment plan. The bridge may have a width between the first side of the patient's lower dental arch and the opposite side of the patient's lower dental arch that is greater than the width between the first side of the patient's lower dental arch and the opposite side of the patient's lower dental arch at a beginning of the corresponding stage of the treatment plan. In any of these examples the at least one tooth-receiving portion may include one or more first tooth-receiving cavities that is shaped to apply tooth aligning forces to straighten or prevent or limit tipping of the one or more first teeth.

Any of these appliances (e.g., individual appliances, or appliances forming part of a system or series of appliances) may include a lingual portion (also referred to as a lingual side or bridge region) that is configured to apply an arch expanding force on teeth effective for lengthening and/or widening the lower dental arch. The lingual portion may be arranged to contact lingual surfaces of one or more of the teeth when the device is worn on a patient's lower dental arch. The lingual portion may have a dimension (e.g., width and/or length) that is greater than a corresponding dimension of the lower dental arch, thereby causing the lingual portion to apply pressure against the teeth when the appliance is worn on the dental arch. The lingual portion may be configured to engage with and apply pressure one or more posterior teeth (e.g., molars and/or premolars) and/or on one or more anterior teeth (e.g., incisors and/or canines). The lingual portion may have a sufficient stiffness to apply an expansion force on the teeth the expand the width and/or length of the dental arch. In some cases, at least part of the lingual portion has a notched (e.g., scalloped) engagement surface to match curved lingual surfaces of the teeth and to maximize engagement with the lingual surfaces of the teeth.

The appliance may include at least one tooth-receiving portion that anchors the appliance to the dental arch. The at least one tooth-receiving portion may include a buccal side, an occlusal side and/or a lingual side that cover one or more teeth of the dental arch. The tooth-receiving portion may have an outer shape that provides a desired bite interaction with the upper dental arch. For example, the tooth-receiving portion may have a cusp shaped outer surface corresponding to the cusp shaped outer surface of toot/teeth in which it covers, which allows the tooth-receiving portion to naturally engage with the tooth cusps of the upper dentition or a dental device on the upper dentition. In other cases, the tooth-receiving portion may have a flat surface. In some examples, the tooth-receiving portion may include one or more bite blocks to adjust the patient's bite (e.g., provide mandibular advancement).

In some examples, the arch expansion involves the use of a series of expansion appliances that are configured to urge the teeth from an initial configuration to a target configuration in a stepwise fashion. Each of the expansion appliances may be a removable polymer shell that is shaped to implement a corresponding stage of a treatment plan.

The appliances may include a polymer shell that is shaped and sized to engage with at least some of the teeth. The polymer shell may have a smooth continuous exterior surface that is free of nooks and crannies that would otherwise accumulate plaque or particles in the patient's mouth. In some cases, each of the appliances are made of a single polymer material. This can provide a seamless feel and look to the appliance that may be more comfortable to wear and less likely to delaminate. In addition, it may be more efficient and/or cost effective to manufacture an appliance made of single material (e.g., using additive manufacturing).

In some cases, the appliances may include openings and/or cutout regions that provide space for primary teeth to exfoliate and/or allow permanent teeth to erupt. The openings and/or cutouts may be arranged such that the appliance does not contact at lease some occlusal and/or buccal sides of the primary teeth so that the primary teeth may shed or be removed.

The appliances may have a varied thickness to provide a desired function and/or aesthetic quality. For example, walls/portions of the appliance that are configured to support pressure and to apply an arch expansion force on the teeth may have a greater thickness than walls/portions of the appliance that are not configured to support such pressure. For example, the lingual portion of an appliance may be thicker than occlusal and/or buccal sides of the tooth-receiving portion(s). In some cases, different regions of the lingual portion may be thicker than other regions of the lingual portion. In examples where the appliance includes an opening and/or cutout region, those regions may have thicker walls to provide lateral stiffness to the appliance. In some cases, buccal and/or labial walls of the appliance may be relatively thin for aesthetic purposes and/or for comfort.

In some examples, the appliances may be configured to straighten the patient's lower dental arch in addition to increasing a width and/or length of the lower dental arch. For example, the expansion force may be distributed among various teeth to align the position/orientation of the teeth with respect to each other in addition to expanding the dental arch. In some cases, the tooth-receiving portion(s) define tooth-receiving cavities with walls that apply tooth alignment forces to urge the teeth toward alignment. For example, buccal, lingual and/or occlusal sides of the tooth-receiving portion(s) may be shaped to apply pressure against teeth, sometimes in a direction unrelated to (or counter to) widening or lengthening the dental arch.

These and other features and aspects are described herein.

All of the methods and apparatuses described herein, in any combination, are herein contemplated and can be used to achieve the benefits as described herein.

### BRIEF DESCRIPTION OF THE DRAWINGS

A better understanding of the features and advantages of the methods and apparatuses described herein will be obtained by reference to the following detailed description that sets forth illustrative embodiments, and the accompanying drawings of which:

FIGS. 1A-1D illustrate examples of lower arch (mandibular) shapes. FIG. 1A shows an example of a generally U-shaped lower arch. FIG. 1B shows an example of a V-shaped lower arch. FIG. 1C shows an example of a generally square-shaped lower arch. FIG. 1D shows an examples of an omega-shaped lower arch.

FIG. 2A illustrates an aerial view of an example lower dental arch showing exemplary expansion forces.

FIG. 2B illustrates an outline view of an example expansion device on a lower dental arch; this expansion device may be part of a series of expansion devices as described herein.

FIG. 3A illustrates an outline view of an example of an expansion device on a lower dental arch, where the device is configured to expose some molars/premolars to allow exfoliation of primary molars/premolars and/or eruption of permanent molars/premolars.

FIG. 3B illustrates an outline view of an example of an expansion device on a lower dental arch, where the device is configured to expose some molars/premolars to allow exfoliation of primary molars/premolars and/or eruption of permanent molars/premolars.

FIG. 4 illustrates an aerial view of another example expansion device on a lower dental arch, where the device is configured to cover all the teeth of the lower arch.

FIG. 5A illustrates a top view of a lower arch expander, where the device includes openings to allow for exfoliation of primary teeth.

FIG. 5B illustrates a bottom view of another example lower arch expander, where the device includes a varied wall thickness and a different tooth-receiving arrangement than the device of FIG. 5A.

FIGS. 6A-6B show examples of lower arch expanders including an occlusal region, but having cut-out regions on either the buccal and lingual sides (FIG. 6A) or on the buccal side (FIG. 6B).

FIGS. 7A-7B show examples of lower arch expander including an occlusal region, but having various cut-out regions on the buccal and lingual sides.

FIGS. 8A-8B show examples of lower arch expander including occlusal cut-out regions. FIG. 8A shows a lower arch expander device with buccal and occlusal cut-out regions. FIG. 8B shows an example of a lower arch expander having occlusal and lingual cut-out regions.

FIGS. 9A and 9B illustrate another example expansion device, where the device is configured to disocclude the anterior teeth of the patient: FIG. 9A shows an aerial view of the device on a lower dental arch; and FIG. 9B shows a side view of the device on the lower dental arch.

FIGS. 10A and 10B show top and front section views, respectively of an example of a lower arch expander including a palatal strut extending up toward the upper arch (e.g., palatal region).

FIG. 11 is a flowchart illustrating an example method of forming a lower dental arch expansion device.

FIG. 12 is a diagram showing an example data structure system for forming a lower dental arch expansion device.

### DETAILED DESCRIPTION

Described herein are apparatuses (e.g., systems and devices) and methods for expanding a patient's lower dental arch. Systems may include a series of expansion appliances that are each configured to incrementally and progressively expand the patient's lower dental arch toward a desired arch configuration based on a treatment plan. Any of the expansion devices described herein may be part of a system including a series of expansion devices for expansion of a patient's lower (mandibular) arch. Methods may include methods for using and manufacturing the expansion appliances.

In some cases it may be desirable to expand a patient's lower jaw in order to allow room for alignment of teeth, to assist in bite alignment, and/or for cosmetic reasons.

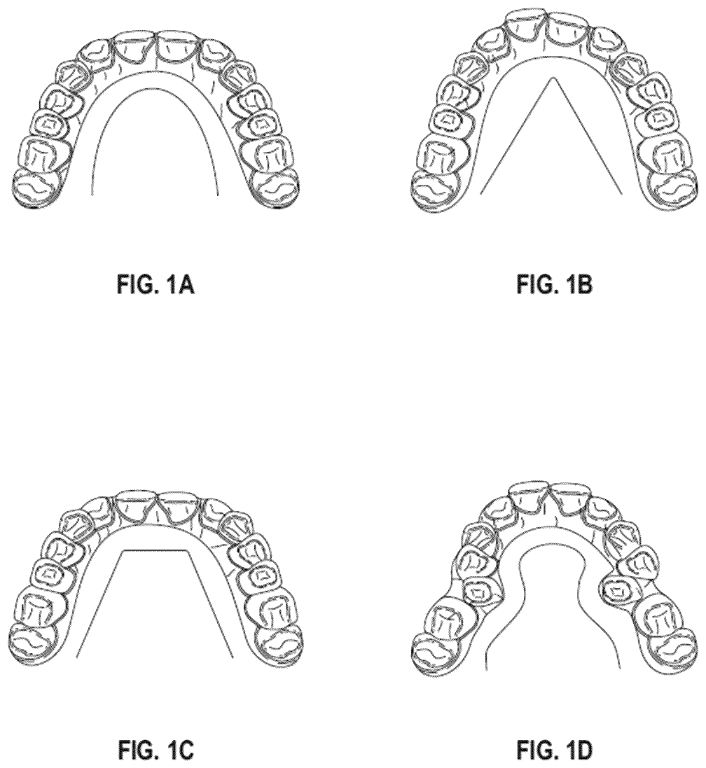

Patient dentition is generally arch shaped, but there is variation from person to person on the form of the arch. Arch forms may be described by an overall shape characteristic, and some forms are preferred over others. For example, arch forms such as V-shaped, square-shaped, and omega-shaped may be associated with crowding of teeth. By contrast, a U-shaped arch form may be considered an ideal in most cases. For example, FIG. 1A illustrates a top (occlusal) view of a lower arch having a generally U-shaped form. FIG. 1B shows an example of a top (occlusal) view of a lower arch having a generally V-shaped form. FIGS. 1C and 1D show examples of square-shaped and omega shaped lower arch forms, respectively. In some cases it may be desirable to expand the lower jaw to provided additional spacing between the teeth. The specifics of the expansion may vary based on a current arch form of the patient. For example, the methods and apparatuses described herein may be configured to broaden, e.g., by symmetrically expanding, a U-shaped lower jaw. In some examples a V-shaped lower jaw (as shown in FIG. 1B) may be generally narrower anteriorly; in some cases a V-shaped lower jaw may be remodeled using a lower jaw expander as described herein to assume a more U-shaped configuration and allow for a more space to allow the teeth better align. A square-shaped lower arch shape, as shown in FIG. 1C may have a more flattened anterior arch shape, and an expansion on this type of arch form may involve applying forces to round out the anterior portion of the arch to assume a more U-shaped configuration. An omega-shaped lower arch, as shown in FIG. 1D, may be broadened as described herein by the application of expansion forces, e.g., on the teeth on opposite sides of the middle region of the lower jaw, to assume a more U-shaped configuration. In some cases, a patient may have a non-symmetric arch form, in which case the expansion would involve applying forces to make the arch symmetrical (e.g., into a U-shaped arch).

The methods and apparatuses described herein may modify a patient's lower arch, including modifying the lower arch so that it assumes a more regular and U-shaped configuration. In particular, described herein are methods of determining a modified lower arch form for the patient that may include comparing the patient's current lower arch form with a target (e.g., U-shaped) lower arch form to determine deviations from the patient's current lower arch form and the target lower arch form, and forming a treatment plan, typically comprising a plurality of treatment stages to modify the patient's current lower arch form so that it approximates or matches the target lower arch form. The method may include dividing the treatment plan into stages, estimating the forces needed to achieve tooth or jaw movement at each stage by applying an expansion force between the teeth on opposite sides of the dental arch, and designing an expander that is configured to apply the estimated force at the determined locations. The stages may be determined based on the amount to force that can be applied between the teeth.

A target lower arch form may be selected based on the patient's current arch, or may be modeled based on the patient's current arch. For example, a target lower arch form may be selected from a library of target lower (e.g., U-shaped) arch forms based on one or more patient characteristics, such as age, gender, initial arch shape, jaw dimensions, etc. Alternatively, a trained neural network may be used to model a target lower arch form. For example, a patient's current arch form may be used as an input into a trained neural network and the neural network may output one or more target lower arch forms; the neural network may be trained from historical treatment data including initial arch forms and expanded arch forms, e.g., arch forms expanded using one or more expander devices as described herein. Although the examples described above include U-shaped target arch forms, the same techniques may be applied to any other target arch from.

For example, a method of modifying a patient's lower arch may include: receiving of generating a digital model of a patient's lower arch, wherein the patient's lower arch has a current lower arch form; identifying a target lower arch form; comparing the patient's current lower arch form with the target lower arch form to identify deviations between the patient's current lower arch form and the target lower arch form; and making a treatment plan, comprising a plurality of treatment stages, to modify the patient's current lower arch form so that it approximates or matches the target lower arch form. In any of these methods identifying the target lower arch form may comprise identifying a target U-shaped lower arch form.

Any of these methods may include designing a lower arch expander for each stage of the plurality of stages, wherein the lower arch expander for each stage is configured to apply the estimated forces between the teeth on opposite sides of the patient's lower arch.

Any of the methods described herein may include making the lower arch expander, and/or having at least one of the lower arch expanders (e.g., of a series of lower arch expanders) made. For example, these methods may include having at least one of the lower arch expanders made by forming a digital file including the design of the at least one lower arch expander and transferring the digital file of the design to a manufacturing system. The manufacturing system may be a direct fabrication system.

In some examples the method may include dividing the treatment plan into the plurality of stages by estimating the forces needed to achieve tooth and/or jaw movement at each stage by applying an expansion force between teeth on opposite sides of the patient's lower arch, and designing a lower arch expander for each stage that is configured to apply the estimated forces between the teeth on opposite sides of the patient's lower arch. For example, dividing the treatment plan into the plurality of stages may include dividing the treatment plan into stages based at least in part on the amount to force to be applied between the teeth.

Identifying the target lower arch form may include selecting the target lower arch form from a library of target lower arch forms based on the patient's current lower arch form. Identifying the target lower arch form may include using a trained neural network to provide one or more target lower arch based on the patient's current lower arch form.

Although the disclosure focuses on lower arch expanders that expand the lower jaw, the disclosure also contemplates using an apparatus with the same features to maintain a current arch in the lower (or upper) jaw. For example, in the case of a patient who has a missing tooth or who has an erupting or unerupted tooth, the surrounding teeth may tend to move or tip inward to block the missing/erupting/unerupted tooth. These surrounding teeth may then impede or prevent the placement of an implant in a missing spot or the proper erupting of the erupting/unerupted tooth. The apparatuses disclosed herein may thus be placed on a patient's dentition maintain the current arch of the dentition. In such a case, the apparatus may be made to conform to the current teeth arrangement of the patient such that there is no expansion force applied.

The lower dental arch has anatomical differences compared to the upper dental arch that require consideration when implementing a lower arch expansion treatment. For example, the upper jaw includes a mid-palatal suture, which is the junction between two bones of the roof of the mouth and that runs from the anterior teeth and the back of the mouth. In children (e.g., under age 18), the mid-palatal suture may not be completely fused together, and thus an upper arch expander may be used to open the mid-palatal suture and widen the upper arch. In contrast, the lower dental arch includes a medial suture located along the midline of the anterior portion of the lower arch, and which is generally limited to the anterior region of the lower arch and fuses much earlier than the upper mid-palatal suture. Thus, lower arch expansion may involve a different set of forces at different regions with respect to the midline of the arch compared to the upper arch. Additionally, the tongue rests at the base of the mouth of the lower jaw, which should be considered in a lower dental arch device design. In general, widening of a dental arch (including the lower dental arch) may include expanding the distance between corresponding lingual points on the teeth in the same arch. The width of the dental arch may be quantified by measuring the distance between these corresponding lingual points. For example, one measure of lower arch width may be determined as the width between the patient's second molars.

A patient's lower arch width may be expanded by a predetermined amount and at a predetermined rate by controlling the forces applied. The arch expansion devices described herein are configured to provide arch expansion forces to the teeth of the lower dental arch that may be customized for a patient's lower dental arch. As used herein, lower arch (mandibular arch) expansion may include the symmetric (or in some examples, asymmetric) lateral widening of the lower arch. Widening may be achieved by applying force between opposite sides of the lower jaw, e.g., between teeth on opposite sides of the lower right and lower left jaw quadrants, between the lower molars (e.g., 17, 18 and/or 19 and 32, 31 and/or 30), between lower bicuspids (e.g., 29 and/or 28 and 20 and/or 21), between canines (27 and 22). Optionally, expansion may include applying force between the 2^{nd} and/or 3^{rd} molars on one side and the first molar and/or second bicuspid on the opposite jaw. For example, expansion force may be applied to separate, or widen, the lateral distance between the third molars, and/or between the second molars, and/or between the first molars, etc.

In general, expansion force may be applied by configuring the lower jaw expander device so that the lateral width of the device, e.g., arch width, is larger than the patient's current arch width between the lingual sides of the lower jaw. For example, the distance between the left tooth-receiving portion and the right tooth-receiving portion is larger than the distance between the lingual sides of the patient's current lower jaw form, and the region between the widened region, e.g., along the lower jaw arch, may be reinforced to apply a force therebetween.

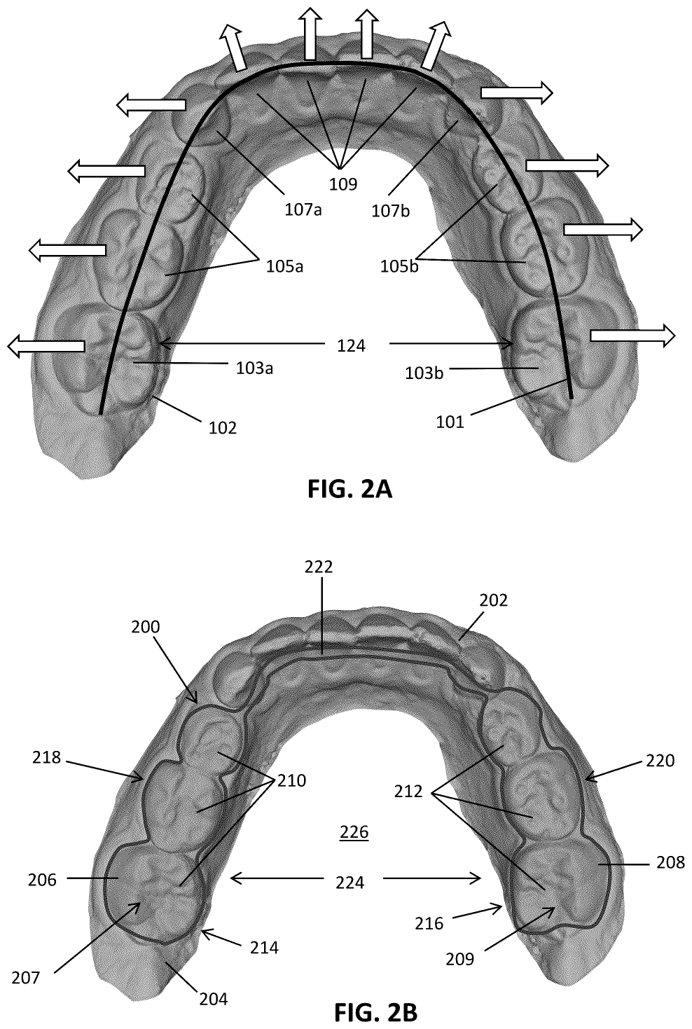

FIG. 2A illustrates an example of a lower dental arch. As used herein, an arch length 101 may refer to the length as measured from a posterior-most molar 103a (in this case a first molar) on one side of the dental arch 102 to a posterior-most molar 103b (in this case a first molar) on the opposite side of the dental arch 102, as measured through points on intervening teeth along an imaginary line. In some cases, the points are at the center of the teeth as measured in aerial (top-down) view. An arch width 124 may refer to the distance between corresponding first molars 103a/103b, corresponding premolars 105a/105b and/or corresponding canines 107a/107b. In some cases, the arch width 124 may refer to an average distance between corresponding molars, premolars and canines. The expansion width may refer to the changed arch width 124 which may be selected and/or calculated as part of a treatment plan, as described herein. A change in (e.g., increase in) expansion width achieved as described herein may refer to the difference between an initial (or prior) arch width and a target arch width, for either one or more stages of a treatment plan, or for the entire treatment, as indicated by the context herein.

Outward forces applied to the teeth (e.g., represented by outward facing arrows in FIG. 2A) may be effective for expanding the arch length 101 and/or the arch width 124 of the dental arch 102. Note that the direction of the arrows representing the outward forces in FIG. 2A are only exemplary and the direction (and magnitude) of the outward forces may vary depending on a patient's specific dentition and treatment plan. The outward forces applied to each tooth may be in a lateral direction (e.g., buccal direction), in an anterior direction (e.g., labial direction), or in a combination of lateral and anterior directions. Expanding the arch length 101 and/or an arch width 124 may increase space between one or more pairs of adjacent teeth to provide room for erupting permanent teeth or for crowded teeth. These adjustments may also correct malocclusions with the upper teeth and/or improve the patient's smile. Often, expansion of the lower arch 102 is implemented with expansion of the patient's upper dental arch.

The arch expanding devices described herein may be configured to apply a customized expansion force on the lower arch 102. The customized expansion force may include a particular combination of outward forces applied to one or more of the teeth of the lower arch 102. For example, the arch expanding devices may be configured to apply outward forces to lingual sides of one or both of the first molars 103a and 103b, one or both of the bicuspids 105a and 105b, one or both of the canines 107a and 107b and/or one or more of the incisors 109. In cases where the second molars and/or third molars are present, the arch expanding devices may additionally or alternatively be configured to apply outward forces to the lingual sides of one or more of the second molars and/or one or more of the third molars. The outward forces on each tooth may be applied in a prescribed direction and/or with a prescribed magnitude according to a stage of a treatment plan. In one example, an arch expanding device may be configured to apply an outward force on the molars 103a/103b, bicuspids 105a/105b, and canines 107a/107b but not any outward force on the incisors 109. In another example, an arch expanding device may be configured to apply an outward force on the molars 103a/103b, bicuspids 105a/105b, canines 107a/107b and incisors 109. In some cases, the arch expanding device may be configured to apply greater outward forces on one or more of the teeth (e.g., sets of teeth) compared to one or more other teeth (e.g., other sets of teeth). For example, the arch expanding devices may be configured to apply a particular outward force between corresponding canines 107a/107b and/or incisors 109 to cause lateral displacement of soft tissue along the medial suture, which may be different than an outward force applied between corresponding premolars 105a/105b and molars 103a/103b where the medial suture does posteriorly extend.

In some examples, the application of force using any of the lower arch expanders described herein to expand the arch may be performed concurrently with aligning of one or more teeth. In some examples, the lower arch expanders may also apply counter-tipping forces configured to rotate teeth crowns lingually. This may be necessary in at least some cases because as the lower jaw is expanded laterally outward by pushing against teeth on opposing sides, the teeth may tend to “tip” outward such that the crowns of the teeth rotate buccally. By applying counter-tipping forces with the lower arch expander, such tipping of the teeth may be countered such that the teeth do not tip or such that the amount of tipping is beneath an acceptable threshold. The lower jaw expanders described herein may apply an outward expansionary force between the teeth of the lower jaw on opposite sides of the lower jaw to expand the lower arch while simultaneously applying one or more additional counter-tipping forces. For example, a counter-tipping force may be applied to a buccal side of a region of the tooth that is closer to the crown of the tooth (e.g., by increasing a rigidity or thickness of the appliance on that region). In general, the methods and apparatus (e.g., software) described herein may account for and include additional tooth movements, including anti-tipping, when designing the one or more lower jaw expanders.

The arch expanding devices may be part of a series of arch expanding devices that are configured to progressively expand the dental arch toward a target tooth arrangement, arch length and/or arch width. A treatment plan may be determined based on, for example, three-dimensional (3D) virtual models of the patient's dental arch (e.g., prior to treatment) and a target dental arch. The target dental arch may have a desired tooth arrangement, arch length and arch width. The treatment plan may be partitioned into multiple incremental stages, typically with one arch expanding device associated with each stage. For example, a treatment plan that includes 25 stages may involve the use of 25 arch expanding devices. An arch expanding device associated with a particular stage of the treatment plan may be configured to move the teeth from a first arrangement at the beginning of the particular stage toward a second arrangement at the end of the particular stage. 3D models of the dental arch at each stage of the treatment plan may be calculated using treatment planning software. In some cases, the treatment plan may be modified, for example, if it is determined that the patient's dentition did not progress as expected at a particular stage of implementing the treatment plan. Virtual models of each of the arch expanding devices may also be rendered in 3D and used as a basis for forming the actual arch expanding devices.

Each of the arch expanding devices of a system (series) of devices may be associated with arch expanding forces that are customized according to a corresponding stage of the treatment plan. For example, a first arch expanding device associated with a first stage of a treatment plan may be configured to apply a first expansion force (e.g., with a first magnitude) on the molars 103a/103b and premolars 105a/105b and a second expansion force (e.g., with a second magnitude) on the canines 107a/107b. A second arch expanding device associated with a subsequent second stage of the treatment plan may be configured to apply a third expansion force (e.g., with a third magnitude) on the molars 103a/103b and premolars 105a/105b that is greater or lesser than the first expansion force, and apply a fourth expansion force (e.g., with a fourth magnitude) on the canines 107a/107b that is greater or lesser than the second expansion force. In this way, the series of arch expanding devices can be customized based on aspects of the lower dental arch as well as a particular condition of a patient's lower arch condition.

Any of the arch expanding devices described herein may be configured to apply an expansion force having a value ranging from 1 Newton (N) to 25 N (e.g., to about 1 N, 3 N, 8.5 N, 10 N, 15 N, 20 N, 22N, etc.) to a patient's lower dental arch. Any of the arch expanding devices described herein may be configured to apply an expansion force having a value ranging from 10 N to 25 N. In certain regions of the lower arch, such as anterior teeth, the expansion force may less than that applied to posterior teeth. For example, the arch expanding devices may be configured to apply an expansion force have a value ranging from 1 N to 5 N (e.g., 1 N, 2 N, 2.5 N, 3 N, or 5 N) on anterior teeth.

As mentioned, any of the arch expanding devices described herein may also be configured to align (e.g., straighten) a patient's teeth. For example, the devices may be configured to apply aligning forces on one or more teeth to align the one or more teeth with respect to other teeth in the lower dental arch and/or in the upper dental arch in addition to arch expanding forces. The tooth aligning forces to straighten the teeth may be integrated into the arch expanding treatment plan. The tooth aligning forces may cooperate with the arch expanding forces to expand the lower arch (e.g., width and/or length) as well as straighten the teeth of the lower arch. For example, the arch expanding forces may also participate in straightening the teeth, In general, tooth aligning forces may be applied to translate (anterior-posterior, lingual-buccal), rotate, and/or tip one or more teeth. Likewise, the tooth aligning forces may also participate in expanding the dental arch. For example, arch expanding and/or alignment forces may cause one or more types of tooth movements, such as translation (e.g., both crown and root move in same direction), tipping (e.g., with greater movement of the crown compared to root), intrusion (axial movement along axis toward apex of root), extrusion (axial movement along axis toward crown), torquing (labio-lingual movement of root compared to tooth), uprighting (movement to correct mesially or distally tilted tooth), and/or rotation (rotation tooth along its own long axis).

FIG. 2B shows an outline of an example lower arch expansion device 200 on a lower dental arch 202. The device 200 includes a first tooth-receiving portion 206 and a second tooth-receiving portion 208. The first tooth-receiving portion 206 is shaped to receive one or more first teeth 210, and the second tooth-receiving portion 208 is shaped to receive one or more second teeth 212. In this case, each of the first and second tooth-receiving portions 206 and 208 is shaped to receive three teeth (molars/premolars). The first tooth-receiving portion 206 has a first lingual side 214 that is shaped to cover at least a portion of the lingual side of one or more first teeth 210 and a first buccal side 218 that is shaped to cover at least a portion of the buccal side of one or more first teeth 210. The second tooth-receiving portion 208 has a second lingual side 216 that is shaped to cover at least a portion of the lingual side of one or more second teeth 212 and a second buccal side 220 that is shaped to cover at least a portion of the buccal side of one or more second teeth 212. In some cases, the first tooth-receiving portion 206 includes an occlusal side 207 that is shaped to cover at least a portion of the occlusal side of one or more first teeth 210, and the second tooth-receiving portion 208 includes an occlusal side 209 that is shaped to cover at least a portion of the occlusal side of one or more second teeth 212. In general, an apparatus (or series of apparatuses) such as those shown in FIG. 2B may be configured to cover just the molar(s) or may cover any other teeth.

In general, these apparatuses may be configured to apply forces directly to the teeth, e.g., within a tooth-receiving region of the lower jaw expander and/or to one or more auxiliaries on the tooth, such as attachments, hooks, etc. Any of these apparatuses may be configured to extend to prevent or minimize contact with the patient's gingiva. Alternatively, they may be configured to contact, and in some cases apply force to, the patient's gingiva. In any of these apparatuses the lower jaw expander may be configured to extend over without substantially contacting the gingiva. In some examples the lower jaw expander may be configured to contact the gingiva at one or more locations. Thus, the lower jaw expanders described herein may be configured to apply force against the teeth and not against the gingiva, or minimally against the gingiva.

In FIG. 2B, the device 200 also includes a bridge region 222 that couples at least a portion of the first tooth-receiving portion 206 to at least a portion of the second tooth-receiving portion 208. For example, the bridge region 222 may couple the first lingual side 214 to the second lingual side 216. The bridge region 222 may be configured to maintain a width 224 between the first lingual side 214 and the second lingual side 216 so that the device 200 provides an expansion force between the one or more first teeth 210 and the one or more second teeth 212 (e.g., in respective buccal directions) when the device 200 is worn on the lower dental arch 202. In some examples, the first lingual side 214 (and/or the bridge region 222) is stiffer and/or thicker than the first buccal side 218 (and/or the first occlusal side 207). Likewise, the second lingual side 216 (and/or the bridge region 222) may be stiffer and/or thicker than the second buccal side 220 (and/or the second occlusal side 209). The stiffer/thicker lingual sides 214/216 (and/or bridge region 222) may support the outward force applied to the lingual surfaces of the one or more teeth 210/212 needed to expand the lower dental arch 202.

The width 224 between the first lingual side 214 and the second lingual side 216 may be wider than the arch width between a first lingual side of the one or more first teeth 210 and a second lingual side of the one or more second teeth 212 (also referred to as the intermolar width). Thus, when the device 200 is placed on the lower dental arch 202, the expansion force may urge the one or more one or more first teeth 210 in respective outward/buccal directions and the one or more one or more second teeth 212 in respective outward/buccal directions. Thus, the expansion force may expand the lower dental arch 202 by increasing the arch width between the between a first lingual side of the one or more first teeth 210 and a second lingual side of the one or more second teeth 212. The expansion force may additionally increase the arch length of the lower dental arch 202.

In cases where device 200 is used on a child, the increased arch width and/or arch length may provide room for erupting permanent teeth, which in turn may allow the permanent teeth to come in straighter, reducing or eliminating the need for orthodontic treatment as a teen or adult.

The expansion force may have a magnitude in accordance with a corresponding stage of a treatment plan. For example, the device 200 may be one device of a series of arch expansion devices that are configured to incrementally expand the lower dental arch 202 toward a desired arch configuration according to multiple stages of a treatment plan. In such cases, the width 224 of each device may be incrementally increased as treatment progresses. For example, a first arch expansion device for a first stage of the treatment plan may have a first width, and a second arch expansion device for a subsequent second stage of the treatment plan may have a second width that is greater than the first width. In this way, each of the arch expanding devices of the series may have a fixed width 224.

Each arch expanding device 200 (e.g., of a series) may be configured to apply an expansion force in a direction and having a magnitude in accordance with the planned stage of the treatment plan. In some examples, each arch expanding device 200 (and any of the arch expanding devices described herein) may be configured to apply an expansion force having a magnitude having a value ranging from 1 Newton (N) to 25 N (e.g., to 1 N, 5 N, 8.5 N, 10 N, 15 N, 20 N, 22 N, 25 N, etc.). This expansion force is greater than some conventional lower arch expanding devices, thereby allowing a quicker and more effective lower arch expansion compared to such conventional devices.

The first lingual side 214, the second side lingual 216 and the bridge region 222 cooperate to form an arch shape that defines a recessed region 226 that is shaped and sized to accommodate the patient's tongue. The recessed region 226 may allow the tongue to rest at the base of the mouth without interference from the device 200.

The device 200 may include a polymer shell 204 that defines the first tooth-receiving portion 206, the second tooth-receiving portion 208 and the bridge region 222. For example, the first lingual 214, buccal 216 and occlusal 207 sides the first tooth-receiving portion 206 and the second lingual 216, buccal 220 and occlusal 209 sides of the second tooth-receiving portion 208 may be comprised of a polymer material. In some cases, the device 200 (e.g., polymer shell 204) is made of a single polymer material. The device 200 (e.g., polymer shell 204) may have a smooth and continuous plastic exterior surface that is free of screws or other mechanisms for expanding the width 224 (e.g., compared to traditional arch expanding devices). These features can make the device 200 more comfortable for a patient to wear and easier for the patient to maneuver compared to arch expanding devices with screws or other expansion mechanisms. In addition, there is no need to turn a screw or other expansion mechanisms, making the device 100 easier to use.

In some examples, the first tooth-receiving portion 206 and/or the second tooth-receiving portion 208 may be configured to additionally apply orthodontic repositioning forces to straighten one or more of the teeth in accordance with a stage of a treatment plan. For example, one or more of the first lingual 214, buccal 216 and occlusal 207 sides and/or one or more of the second lingual 216, buccal 220 and occlusal 209 sides may be shaped to apply force(s) to the one or more first teeth 210 and/or the one or more second teeth 212 in direction(s) toward target position(s) in accordance with a treatment plan that include straightening the position(s) of the tooth/teeth relative to a target dental arch. Such repositioning forces may cooperate with the arch expanding forces to expand the arch and straighten the teeth.

In some cases, the first tooth-receiving portion 206 and/or the second tooth-receiving portion 208 may include one or more attachment receiving cavities that are configured to receive corresponding dental attachment(s) bonded to the patient's tooth/teeth. The dental attachment(s) may be bonded to specific location(s) on the tooth/teeth and have specific shape(s) to promote a prescribed tooth/teeth movement (e.g., according to a stage of a treatment plan).

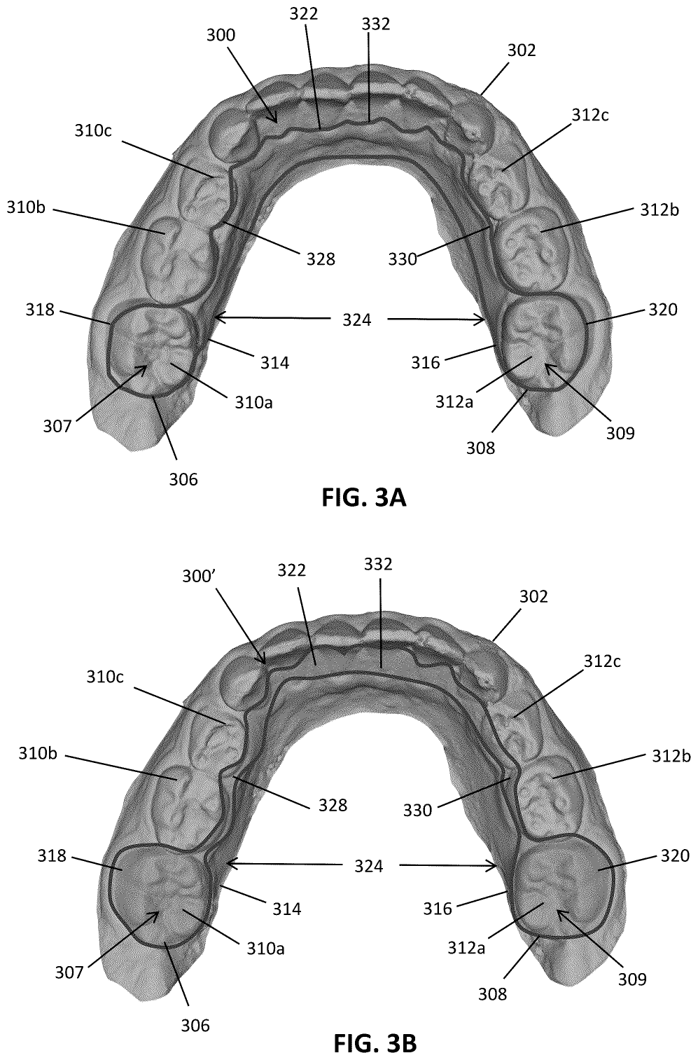

FIG. 3A illustrates another example of a lower arch expansion device 300 on a lower dental arch 302. The device 300 is similar to device 200 except that a first tooth-receiving portion 306 and a second tooth-receiving portion 308 are configured to cover only a portion of the molars and/or premolars of the lower dental arch 302. In this case, the first tooth-receiving portion 306 is configured to cover a single tooth 310a on one side of the arch 302 and the second tooth-receiving portion 308 is configured to cover a single tooth 312a on the opposing side of the arch 302. This configuration leaves the occlusal surface of the teeth 310b, 310c, 312b and 312c uncovered, for example, to allow these teeth to exfoliate (if primary teeth) and/or provide room for eruption of permanent teeth. This configuration may also be more aesthetically desirable as the device 300 does not cover buccal and labial sides of teeth that may be visible when worn in the patient's mouth.

The first tooth-receiving portion 306 has a first lingual side 314, a first buccal side 318 and an occlusal side 307 Likewise, the second tooth-receiving portion 308 has a second lingual side 316, a second buccal side 320 and an occlusal side 309. A bridge region 322 couples the first lingual side 314 to the second lingual side 316 and maintains a width 324 between the first tooth 310a and second tooth 312a. The bridge region 322 of the device 300 is longer and extends farther in the posterior direction compared to the bridge region 322 of the device 300. In addition, surfaces 328 and 330 of the bridge region 322 that are arranged to contact lingual surfaces of the teeth 310b, 310c, 312b and 312c have a scalloped shape to increase engagement with the teeth 310b, 310c, 312b and 312c, thereby allowing the device 300 to also apply a sufficient arch expanding force between first teeth 310b and 310c and second teeth 312b and 312c. The first lingual side 314 (and/or the bridge region 322) may be stiffer and/or thicker than the first buccal side 318 (and/or the first occlusal side 307). Likewise, the second lingual side 316 (and/or the bridge region 322) may be stiffer and/or thicker than the second buccal side 320 (and/or the second occlusal side 309). The stiffer/thicker lingual sides 314/316 (and/or bridge region 322) may support the outward force applied to the lingual surfaces of the one or more teeth 310a, 310b, 310c and 312a, 312b, 312c needed to expand the width of the lower dental arch 302 according to a corresponding stage of a treatment plan.

In some examples, the arch expanding devices described herein may include a bridge region having a shape that is configured to increase the arch depth (in the anterior to posterior direction) of the lower dental arch. For example, the bridge region (e.g., 222 or 322) may be configured to engage with the lingual surfaces of the anterior teeth and be shaped and sized to apply a force in the anterior direction to increase the arch depth. In some examples, such as in the device 300 of FIG. 3A, the bridge region 322 has a scalloped shaped anterior surface 332 that is shaped to increase engagement with lingual surfaces of the anterior teeth. FIG. 3B is similar to the device shown in FIG. 3A, but in which the expander device 300′ is configured to minimize contact with the patient's gingiva.

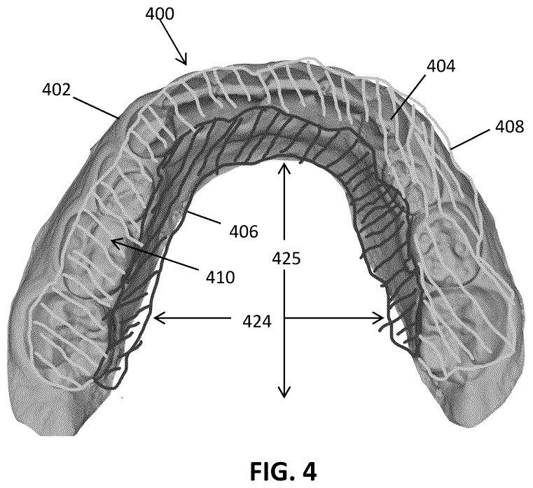

FIG. 4 illustrates another example of a lower arch expansion device 400 on a lower dental arch 402. As with the devices 200 and 300, the device 400 may be a polymer shell. The device 400 includes a tooth-receiving portion 404 that defines multiple tooth-receiving cavities that are shaped to receive a corresponding number of teeth. The tooth-receiving portion 404 includes a lingual side 406, a buccal side 408, and an occlusal side 410. In this case, the tooth-receiving portion 404 is configured to cover all the teeth of the dental arch 402. A lingual portion lingual side of the device 400, which corresponds to the lingual side 406 of the tooth-receiving portion 404, is arranged to contact lingual surfaces of the teeth when the device 400 is worn on a patient's lower dental arch. The lingual portion 406 is shaped and sized to apply an arch expanding force (e.g., outward force) on the teeth to lengthen and/or widen the dental arch 402.

For example, the lingual portion 406 may have an arch width 424 between opposing teeth (e.g., opposing molars, premolars, canines and/or incisors) that is/are wider than the width of the lower arch 402 (e.g., at the beginning of a corresponding stage of a treatment plan). At least a portion of the lingual portion 406 may be stiffer and/or thicker than the buccal side 408 and/or the occlusal side 410 so that the lingual portion 406 can apply an expansion force between opposing posterior teeth, e.g., in accordance with a stage of the treatment plan.

In some cases, the device 400 may additionally be configured to increase the depth 425 of the lower arch 402 by applying a force in the buccal direction to the anterior teeth. For example, a depth 425 of the device 400 may be greater than a depth of the lower arch 402 (e.g., at the beginning of a corresponding stage of the treatment plan), thereby creating an outward force on the anterior teeth. Alternatively or additionally, the apparatus may include or be configured for use with one or more auxiliaries, e.g., buttons, attachments, etc. For example, the apparatus may be configured to include and/or operate with one or more buttons, hooks, etc. and/or an elastic (e.g., band), between a first, second or third molar and a canine or bicuspid (or first molar) of either the lower jaw or, optionally on an upper jaw or device worn on the upper jaw.

As described above, any of the lower arch expansion devices described herein may be configured to apply orthodontic alignment forces to straighten one or more teeth, for example in accordance with a stage of a treatment plan. For example, in the example of device 400, the tooth-receiving cavities 404 (e.g., one or more of the lingual side/portion 406, the buccal side 408, and the occlusal side 410) may be shaped to apply orthodontic alignment forces to straighten one or more of the teeth of the lower arch 402. In some cases, the device 400 (e.g., the buccal side 408) includes one or more attachment cavities that is/are shaped to accept one or more corresponding attachments bonded to one or more teeth so that the attachment(s) may provide leverage and enhance the orthodontic alignment forces.

In general, the apparatuses and methods described herein may accommodate exfoliation and/or eruption of teeth, which may be particularly helpful when treating younger patients, having a mixed dentition of both permanent and primary teeth, and for whom expansion of the lower (and/or upper) jaws may be very beneficial. For example, any of the lower jaw expanders described herein may include one or more cutout regions on any of the buccal, lingual, and/or occlusal region of the lower jaw expander. In any of these methods and apparatuses, the clinician (e.g., doctor or other dental practitioner) may select the cutout region for all or some of the teeth, including all or some of the patient's primary and/or erupting tooth, and may determine if a cut-out and/or reinforced region is desired. For example, the methods and/or apparatuses (e.g., software, etc.) may be configured to allow a dental professional to select a cutout region (e.g., buccal, lingual, and/or occlusal) for each tooth based on the patient's teeth eruption status, such as erupting from buccal or lingual side, and/or based on the treatment purposes, such as avoiding eruption interference, avoiding over eruption, guiding tooth eruption, etc. The same techniques may be applied for both the lower jaw expander and an upper jaw expansion apparatus. For example, a dental professional may select a cutout region of the lower jaw and upper arch expansion devices based on the patient's needs. A dental professional may customize the expansion device(s) for each patient according to patient's treatment need.

In general, one or more cut-out regions may be included in areas where eruption is occurring or is likely to occur, in order to avoid interference with the eruption. In some examples, the cut-out regions may include an occlusal overhang along an occlusal side, where the vertical height of the occlusal overhang is set to prevent over-eruption. The cut-out region may form a window through the device, e.g., may be enclosed along its perimeter, or it may be continuous with the edge of the device. In any of these apparatuses the cut-out region may include a thicker edge region.

In general, the lower arch expansion devices can provide a large arch expansion force as needed. The first molars may be stable for the treatment. Other permanent teeth may be still erupting, or primary teeth may not be exfoliated yet, and may be treated differently from permanent teeth. One or more cut-out regions may be included in order to address various scenarios when treating a patient. For example, in some cases it may be desirable to avoid interference to tooth eruption. Teeth may erupt on- or off- the midline of the arch. Thus, one or more cut-out regions may be included on a buccal and/or lingual side of the lower arch expander to accommodate the erupting tooth. In some cases it may be desirable to avoid over-eruption of a tooth, and therefore the lower arch expander may have an occlusal overhang over the erupting tooth, which may contact the inside of the lower arch expander opposite the occlusal surface; this contact may slow eruption or direct eruption of the tooth.

In some cases it may be desirable to guide a tooth that is erupting, e.g., so that it erupts into a position that is desirable. Thus, in any of these examples the lower arch expander may be configured to guide tooth eruption by constraining the erupting tooth from the buccal and/or lingual side; thus, the lower arch expander may include the buccal and/or lingual sides. For example, this guiding may be performed to guide the eruption of a tooth so that the tooth erupts normal to the arch.

In general, it may be desirable to enhance the stiffness of any of the lower arch expanders described herein, as mentioned in greater detail below, this may include increasing the thickness of the lower arch expander in a continuous line extending between the teeth between which the lower arch is being expanded (e.g., between the left and right molars). Thus, even where the apparatus includes one or more cut-out regions, the lower arch expander may be configured to apply force between one or more pairs (or paired regions) of the teeth, by including a force-transmitting path, which may be formed from a path of thicker material, and/or of reinforced material. In any of these apparatuses the cut line (the one or more edges of the apparatus extending toward the gingiva) of the lower arch expander may be extended and/or reinforced.

The apparatuses described herein may have enhanced device integrity, e.g., overall integrity, and/or regions of enhanced integrity. For example, these apparatuses may be configured to have consecutive surfaces, e.g., buccal, lingual, occlusal, and/or extended cut lines between two or more neighboring teeth that are thicker, and/or are reinforced. Any of these apparatuses may be reinforced by including one or more additional materials and/or layers that may enhance the strength and/or stiffness of the material forming this region of the lower arch expander.

In some examples, the lower arch expander may be configured to allow exfoliation and/or to prevent interference with tooth eruption, e.g., by including an occlusal overhang over the region where the tooth is erupting and/or over the tooth that will be exfoliating.

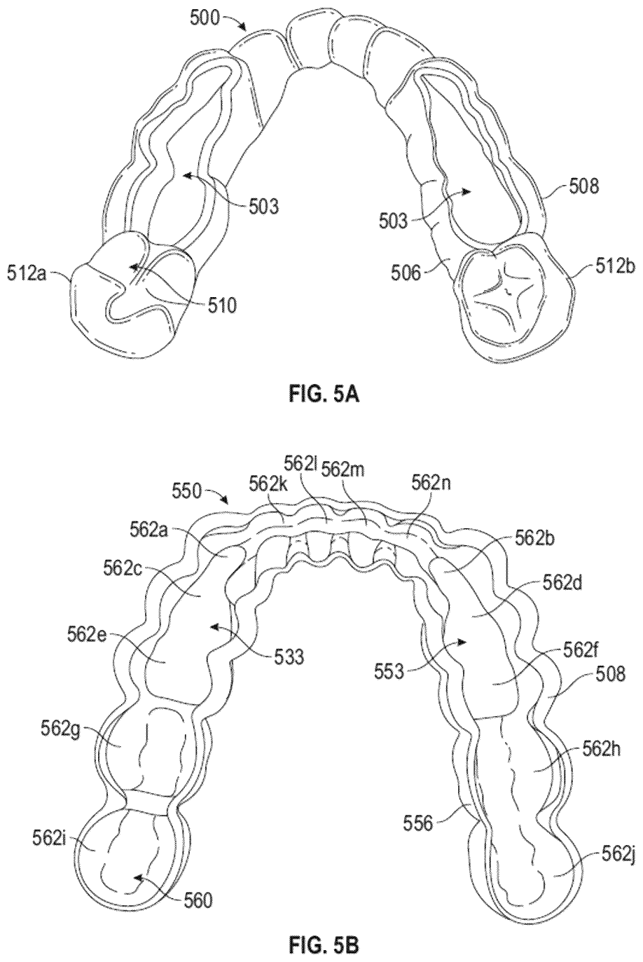

Thus, a dental practitioner (e.g., doctor, technician, etc.) may customize any of the lower arch expander and method of making and using them described herein to include one or more cut-out regions with a suitable occlusal overhang and/or reinforced regions in order to achieve any of these goals. As described in greater detail in reference to FIGS. 5A-5B, 6A-6B, 7A-7B, and 8A-8B below, the dental professional may customize the lower arch expanders for a single treatment (e.g., single lower arch expander) or more preferably, over a series of lower arch expanders, by including one or more cut-out region.

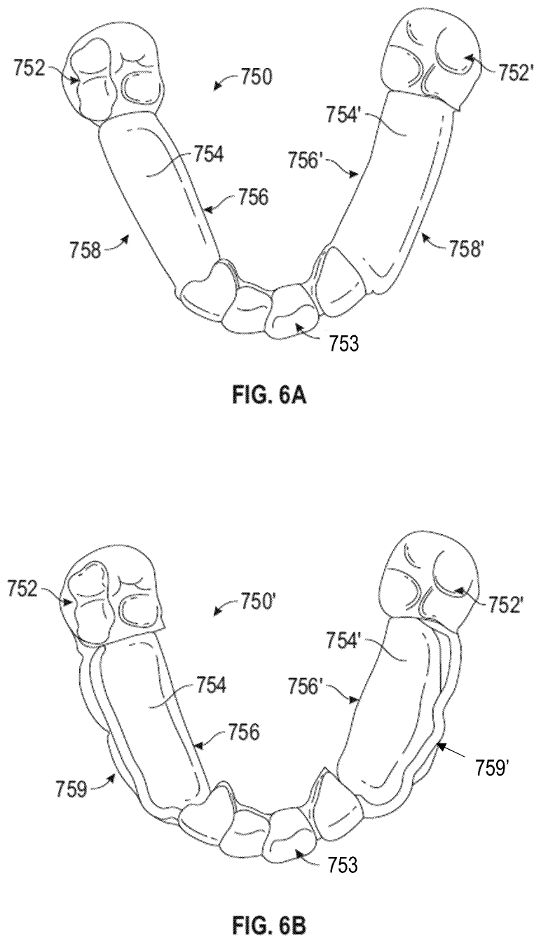

In general, when including one or more cut-out regions, the lower arch expanders described herein may be configured to continue to apply an expansion force between the teeth to expand the teeth of the lower arch; thus, any of the expanders described herein may adjust the forces applied to maintain an expansion force in order to accommodate the removal of all or part of the lingual, occlusal, and/or buccal sides. In any of these examples the force-transmitting path between the two sides of the lower arch expander may be thickened and/or reinforced in order to maintain the applied expansion force. The force-transmitting path may follow a curvature of the arch, including along a lingual, buccal, and/or occlusal side. For example, in some variations (see, e.g., FIGS. 6A, 6B, 7A, 7B and 8B) all or a portion of a lingual wall may be cut out. The apparatuses (e.g., systems) described herein for designing and/or making a lower arch expander may configure the lower arch expander to add additional force to the left and/or right side, e.g., by making the remaining portion of the lingual wall thicker, and/or including a force transmitting path (that may also be thicker and/or reinforced) to transmit the expansion force between the left and right sides of the lower arch.

Reinforcement may include adding a material that is selected and capable of transmitting the expansion force without permanently deforming. For example, a reinforcement may include a reinforcement material (e.g., a metallic and/or polymeric material, and in particular, materials having a relatively high stiffness, k, or flexural and/or tensile modulus, e.g., sufficient to transmit between about 1 Newton (N) and 25 N or 10 N to 25 N as an expansion force between the teeth without permanently deforming). The force-transmitting path may be continuous. In some examples the force-transmitting path may be configured as a thickened region that extends continuously along one or more of the buccal, lingual and/or occlusal sides of the lower arch expander, but that terminated in a lingual surface (or a lingual and occlusal) configured to contact the patient's teeth to apply the expansion force. In some cases the expansion force-transmitting path ends in the region of the apparatus that is configured to hold the molar(s).

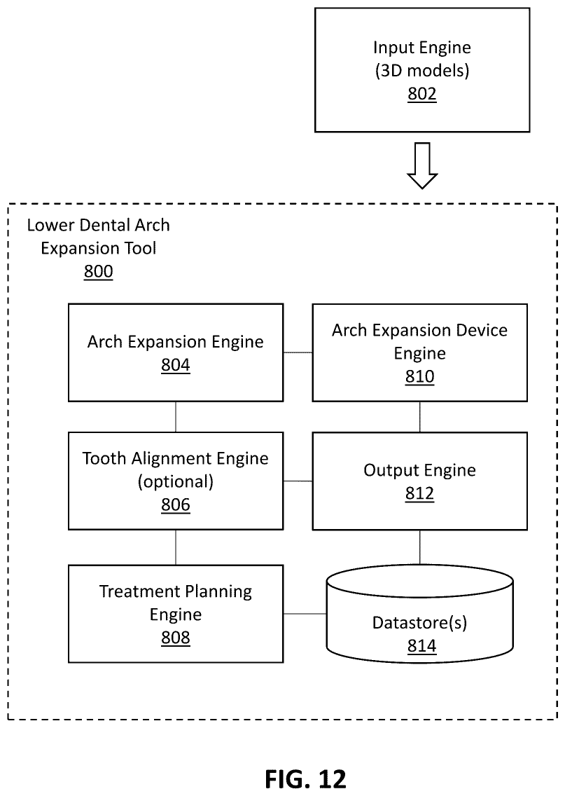

In general the lower arch expander may be configured by the one or more design tools described herein, including the lower dental arch expander tool (see FIG. 12, below) to transmit the expansion force, including modeling the forces acting on the teeth based on one or more digital models of the patient's teeth and one or more digital models of a lower arch expander that may be virtually designed, modified, tested and revised before being finalized and fabricated. In some cases the expansion force transmitting path may be simulated and adjusted, manually, semi-automatically or automatically, to adjust the position and magnitude of the expansion force applied.

FIGS. 5A and 5B illustrate examples of lower arch expander devices that include openings on the occlusal side to allow exfoliation and/or eruption of teeth. FIG. 5A shows an example of a lower arch expansion device 500 that includes openings 503 on the occlusal side 510. The openings 503 are arranged to allow exfoliation of one or more primary teeth of the patient's lower dental arch and/or eruption of permanent teeth. In this case, the openings 503 are formed in occlusal sides of six tooth-receiving cavities (three on each side). As shown, the tooth-receiving cavities with the openings 503 include a buccal side 508 and a lingual side/portion 506, which may increase the lateral stiffness of the device 500.

In addition, two of the tooth-receiving cavities 512a and 512b for posterior teeth (molars) have occlusal sides 510 that are free of perforations, thereby providing more lateral stiffness to the device 500 in this region. Further, the tooth-receiving cavities 512a and 512b may have an undercut geometry in which the edges of the tooth-receiving cavities 512a and 512b close to the gingiva point slightly inward and follow the curvature of the molars near the gingiva. This undercut feature may distribute the forces applied to the teeth closer to the root, thereby reducing or preventing tooth tipping.

FIG. 5B illustrates a further example of a lower arch expansion device 550 that is similar to the device 500 except that the device 550 has a varied wall thickness and a different arrangement of tooth-receiving cavities. Specifically, the walls of tooth-receiving cavities 562a, 562b, 562c, 562d, 562e and 562f (for canine and premolars), which include openings 553, have a greater thickness than the walls of tooth-receiving cavities 562g, 562h, 562i, and 562j (for first and second molars) and/or the walls of tooth-receiving cavities 562k, 562l, 562m, and 562n (for central and lateral incisors) The greater thickness of the walls of tooth-receiving cavities 562a, 562b, 562c, 562d, 562e and 562f may compensate for the presence of the openings 553 in maintaining a lateral stiffness of the device 550. The thickness of the walls may be tuned based on a desired lateral stiffness of the device 550. In addition, the device 550 includes four tooth-receiving cavities 562g, 562h, 562i, and 562j that are configured to cover occlusal surfaces of corresponding first and second molars of the patient's lower arch (compared to two tooth-receiving cavities configured to cover occlusal surfaces of corresponding first molars in device 500). The total tooth receiving portion 560 may include all of the tooth receiving cavities. In FIG. 5A and 5B, the region of the device between the tooth-receiving cavities 562g, 562h, 562i, and 562j (for first and second molars) may be referred to as the bridge region and may be configured to transfer the expansion force, as described.

Any of the arch expanding devices described herein may include walls of varied thicknesses (i.e., not just limited to the example device 550 of FIG. 5B). The varied thickness in different regions of the device may serve to provide varied stiffness to the different regions. In the example of device 550, the greater thickness of the walls surrounding the openings 553 enhances a lateral stiffness of the device 550. In the examples of devices 200, 300, 400 and 500, the lingual portions (e.g., lingual sides and/or bridge regions) may have greater thickness to provide sufficient stiffness for applying the expansion (e.g., outward) forces. Other regions of the devices may have lesser thickness to provide other functionality, such as greater flexibility, increased comfort and for providing proper resilient alignment forces on the teeth.

Thus, any of the lower arch expanders described herein may include one or more cut-out regions forming windows through the expander. In some cases the lower arch expander may be customized, e.g., by a dental professional, to include an occlusal region that acts as a bridge region (and includes the expansion force transmission path) between two tooth-receiving cavities at either end of the arch that are configured to hold the molars 556 (e.g., first and/or second and/or third molars), with all or a portion of the more anterior buccal and lingual sides absent. For example, FIG. 6A illustrates an example of a lower arch expander 750 that includes tooth receiving cavities 752, 752′ to receive a patient's molars as well as an anterior cavity region 753 to receive the anterior teeth; a pair of occlusal bridge regions 754, 754′ connect the cavities. The occlusal bridge regions and the anterior cavity region forms the bridge region that transmits the expansion force between the tooth-receiving regions. There are two cut-out regions on the lingual sides 756, 756′ and two cut-out regions on the buccal sides 758, 758′. The lower arch expander in FIG. 6A may prevent interference with erupting and/or exfoliating teeth that are laterally off of the central arch of the lower jaw.

FIG. 6B shows another variation of a lower arch expander 750′ including of cut-out regions 756, 756′ on the lingual sides, but the full buccal sides 759, 759′ are included along with the occlusal sides 754, 754′. In this example the expansion force transmitting path may extend between the two posterior tooth receiving cavities 752, 752′ on either ends of the device along either or both the occlusal regions 754, 754′ and/or the buccal sides 759, 759′ (as well as through all or a portion of the anterior tooth receiving cavity 753). This variation may prevent interference with erupting and/or exfoliating teeth that are lingually inward from the central arch of the lower jaw.

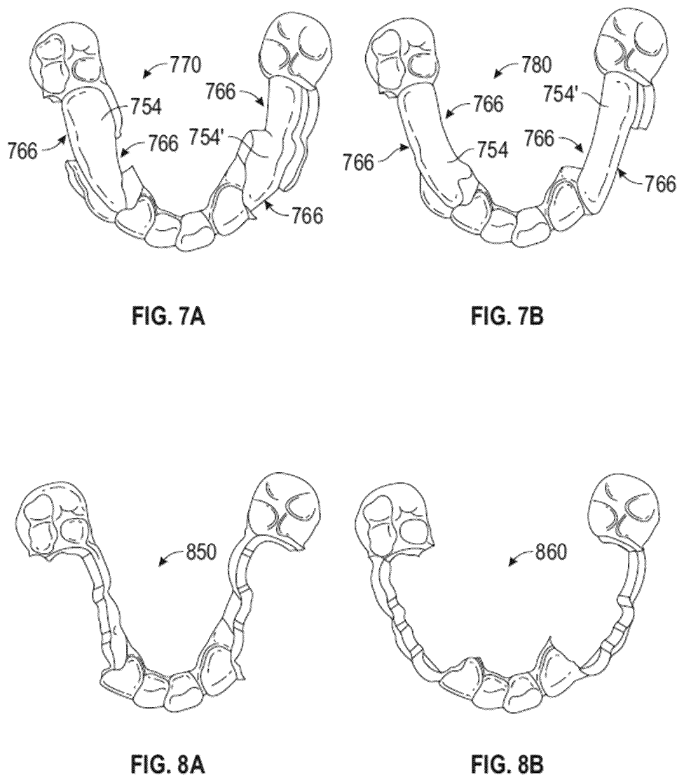

FIG. 7A illustrates another example of a lower arch expander 770 including cut-out regions, similar to those shown in FIGS. 6A-6B. In FIG. 7A the expander includes a pair of occlusal bridge regions 754, 754′ and partial cut-outs 766 in both the buccal and lingual sides. FIG. 7B shows a lower arch expander 780 that includes cut-out regions 766 in the buccal and lingual sides at different positions along the arch than in the example shown in FIG. 7A.

FIGS. 8A and 8B illustrate examples of lower arch expanders that include cut-out regions in the buccal portion of the expander. For example, FIG. 8A shows a lower arch expander 850 in which large, bilateral portions of the buccal and occlusal regions are cut out, leaving an expansion force path along the lingual sides. Alternatively, FIG. 8B shows a lower arch expander 860 in which large, bilateral portions of the lingual and occlusal regions are cut out, and the expansion force path travels through the buccal sides.

In any series of lower arch expanders, some or all of the lower arch expanders may include cut-out regions. Thus, different lower arch expanders in a series may have different cut-out regions, depending on the goals for the treatment. For example, cut-out regions may be arranged on any of the lower arch expanders to prevent it from interfering with movement, eruption and/or exfoliation of one or more teeth.

### Auxiliaries

Any of the lower arch expander apparatuses and methods described herein may include one or more auxiliar structures (“auxiliaries”) for use with the lower arch expander. In general an auxiliary may modify the forces applied by the lower arch expander, and/or may modify the connection between the lower arch expander and the teeth. Auxiliaries may include attachments, buttons, hooks, bite blocks, ramps, elastics, etc.

In some examples the lower arch expander apparatuses described herein may be used with one or more attachments. Attachments may be bonded to the patient's teeth and may engage with attachment receiving sites (e.g., cavities, pockets, etc.) on the lower arch expander apparatus. Attachments may include one or more attachment surface for engaging with the lower arch expander apparatus; for example, a lower arch expander apparatus may include attachment receiving sites that may each couple with an attachment bonded to the patient's teeth to help secure the lower arch expander apparatus to the teeth and may apply force to the teeth and/or may transfer force between the lower arch expander apparatus and the teeth. Attachments may be bonded to any appropriate tooth or tooth region, including to the buccal surface and/or lingual surface of the teeth.

Alternatively or additionally, the lower arch expander apparatuses described herein may include one or more buttons or hooks formed on an outer surface of the lower arch expander apparatus. In some examples the buttons or hooks may be configured to apply a distalizing force and/or a force pulling one or more teeth proximally or anteriorly. Buttons or hooks may be configured to be used with an elastic (e.g., band) or a wire, rod, etc.

Any of the devices or systems described herein may include one or more bite adjustment structures (e.g., bite blocks) that are configured to adjust the patient's bite. The bite adjustment structure(s) may protrude from one or more of the buccal, labial, occlusal and/or lingual sides of the device. The bite adjustment structure(s) may be shaped and arranged to contact the patient's upper dental arch or a dental device on the patient's upper dental arch to affect relative upper and lower jaw positions when the patient bites. In some specific examples, the bite adjustment structure(s) are configured to provide mandibular advancement relative to the maxilla.

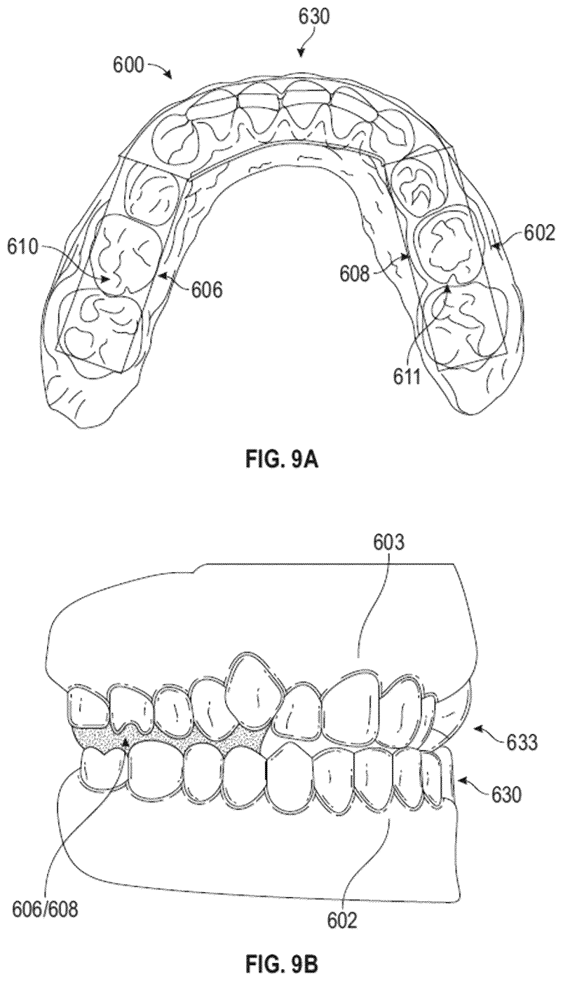

FIGS. 9A and 9B illustrate another variation of a lower arch expansion device 600 that is configured to disocclude the anterior teeth of upper and lower dental arches of the patient by causing the upper and lower anterior teeth to be separated from each other. Disocclusion of the jaws may be particularly useful to help correct certain malocclusions such as an overbite or an underbite, where one jaw needs to be advanced with respect to another. For example, one or more protrusions (e.g., bite ramps) may be included on the lower arch expander apparatus (e.g., along one or more posterior teeth) such that when a patient bites down, the anterior teeth are vertically separated. In some examples, the projections may be formed of the same material as the rest of the lower arch expander and may be formed by increasing a thickness of portions of the lower arch expander (e.g., along portions configured to be placed on posterior teeth). Disocclusion using any of these devices may also or alternatively be useful to treat crossbite. In any of these examples, the lower arch expander apparatus may include a disocclusion member on the occlusal side of the lower arch expander apparatus. For example, in FIGS. 9A and 9B, the device 600 includes a first tooth-receiving portion 606 and a second tooth-receiving portion 608 that are shaped to receive opposing posterior teeth; in this case, the first molars and the first and second premolars. The occlusal sides 610 and 611 of the first and second tooth-receiving portions 606 and 608 have thicknesses that are sufficiently large to prevent the anterior teeth 630 of the lower dental arch 602 from contacting the anterior teeth 633 of the upper dental arch 603, as shown in FIG. 9B. In this example, the patient may have an overbite or an underbite that requires a treatment including the advancement of one jaw with respect to another. As illustrated in FIG. 9B, the anterior teeth of the upper and lower dental arches are vertically separated from each other. By introducing this vertical separation and preventing contact between the anterior teeth of the upper and lower jaws, it becomes easier to advance one jaw with respect to the other jaw using a dental appliance (e.g., advance the lower jaw with respect to the upper jaw, or vice versa). In some examples, the protrusions may be bite ramps on the anterior teeth so as to disocclude the posterior teeth and enable corrective movement of the posterior teeth in correcting a malocclusion. In other variations, tooth-receiving portion(s) on the anterior teeth may have an added thickness along the occlusal (incisal edge) side to disocclude posterior teeth.

In some examples, the outer occlusal surfaces of the occlusal sides 610 and 611 are cusp shaped, for example, corresponding to the cusp shaped occlusal surfaces of the underlying teeth. This may allow the occlusal sides 610 and 611 to mate with matching cusp shaped surface of the posterior teeth of the upper dental arch 603 and/or a second dental device on the upper dental arch 603. In other cases, the outer occlusal surfaces of the occlusal sides 610 and 611 are flat. Any of the devices described herein (e.g., devices 200, 300, 400, 500 or 550) may have a tooth-receiving portion with an occlusal side that has a cusp shaped outer surface or a flat outer surface.

Any of the devices described herein may include one or more features to facilitate removal and/or placement of the device on the patient's dental arch. In some examples, the device includes one or more tabs that a user may grasp, pull and/or push to provide leverage for removal and/or placement of the device. In some cases, the tab(s) extend from an edge (e.g., buccal edge) of the device at or near the gingiva. In some cases, the devices may include one or more hinges that predictably bend the device in a manner that provide space for easier removal and/or placement of the device on the teeth.

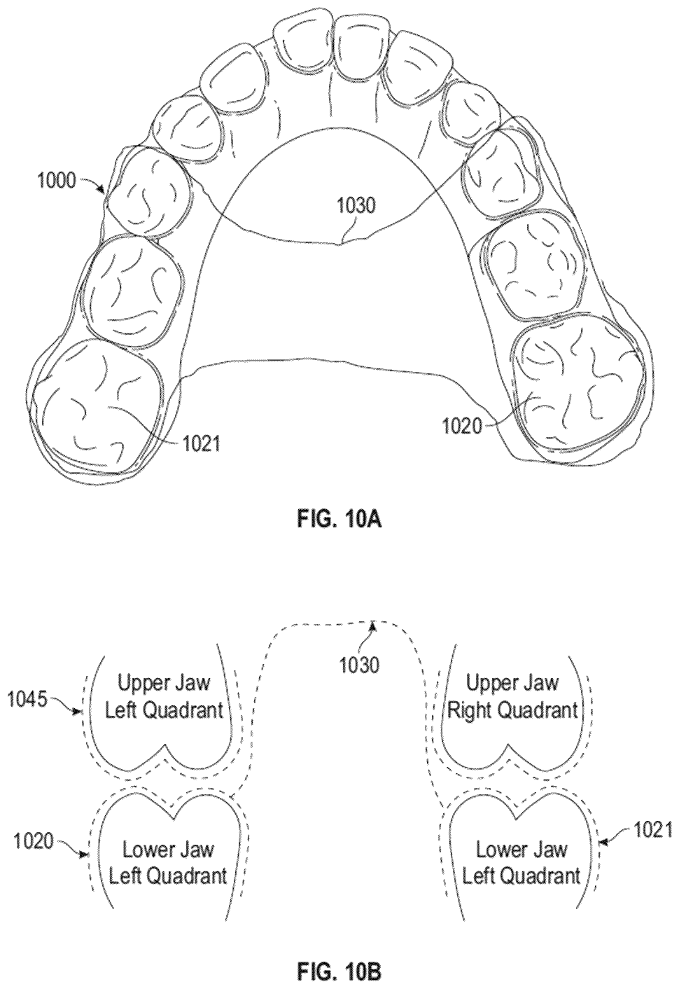

FIGS. 10A-10B illustrate another example of a lower-jaw expander, in which additional leverage for expansion is provided by one or more palatal struts extending inward and vertically upward from the body of the lower arch (e.g., the lingual sides) towards the palate when the device is worn. A palatal strut may be configured to arch over the oral cavity to allow for a space (e.g., a channel or tunnel) for the tongue such that the tongue can pass therethrough unimpeded. The palatal strut may provide additional expansion force against the mandibular jaw, enabling the application of direct lateral force across opposite sides of the dental arch for lateral expansion. The palatal strut may at least partially cover the region extending from the occlusal/lingual interconnect point to avoid contact with the tongue and the upper jaw. In some examples the strut may be configured to provide a clearance from at least a portion of the palatal surface to prevent direct contact with some or all of the palatal surface. In some examples, the strut may contact the palatal surface.

For example, FIG. 10A shows a top view of a lower arch expander 1000 including a palatal strut 1030 that connects the lingual sides of a pair of tooth-engaging portions 1020, 1021 having tooth-receiving cavities that are configured to fit over the patient's molars and/or premolars. FIG. 10B shows a sectional front view. As shown the lower arch expander may be worn with an upper arch aligner or expander 1045. Although FIGS. 10A and 10B illustrate a single wide strut 1030, in some examples, a plurality of struts (e.g., narrow bars) may be used to apply a similar expansion force.

In some examples, the palatal strut 1030 may be formed integrally with the tooth-engaging portions 1020, 1021. For example, the palatal strut 1030 and the tooth-engaging portions 1020, 1021 may be directly fabricated (e.g., by 3D printing) as one integral part. In some examples, the palatal strut 1030 may be formed separately and may be subsequently attached to the tooth-engaging portions 1020, 1021. In some examples, the palatal strut 1030 may have a different rigidity or thickness than the tooth-engaging portions 1020, 1021. For example, the palatal strut 1030 may be more rigid or thicker than the tooth-engaging portions 1020, 1021 so as to be able to exert a higher amount of expansion force. In some examples, palatal strut 1030 may be made of a different material than the tooth-engaging portions 1020, 1021 such that they have different force application characteristics. For example, the tooth-engaging portions 1020, 1021 may be made of a polymer material, while the palatal strut 1030 may be made of a metal (e.g., a shape memory metal such as nitinol). In general, the characteristics of the palatal strut 1030 can be customized based on patient characteristics (e.g., age) and/or treatment (e.g., amount of expansion force necessary). Having this separate source of expansion force not only provides greater expansion force; it also provides greater flexibility in how forces can be applied during a treatment.

In some examples, dental appliances such as the lower arch expander disclosed herein may include features to correct particular oral habits. For example, a barrier structure may be placed on a lingual side of a dental appliance (e.g., a lower arch expander) to reduce or prevent tongue thrust. This barrier structure may extrude vertically and/or lingually from or near a gingival lingual edge of the dental appliance and may thus impede or prevent the tongue from getting pushed outward. As another example, a barrier structure may be placed on a lingual side of an upper or lower dental appliance to impede or prevent a patient's thumb from being inserted into the mouth to reduce or prevent thumb sucking. In some examples, the barrier structures may be continuous laterally. In some examples, the barrier structures may have perforations or surface alterations like channels or ridges. The barrier structures may be formed integrally with the dental appliance (e.g., directly fabricated by 3D printing, sintering, or otherwise; thermoforming; etc.) or may be formed separately and then attached to the dental appliance subsequently. More information about structures (e.g., barriers) on dental appliances for habit correction may be found in U.S. Pat. No. 11,026,831, which is incorporated herein by reference in its entirety.

The devices described herein may be manufactured using any of a number of manufacturing techniques. For example, the devices are made using one or more of an additive manufacturing (e.g., 3D printing), molding and/or etching process. Additive manufacturing techniques may be well suited for fabrication of the devices due to the customizability of additive manufacturing. For example, a series of devices according to an incremental treatment plan may be virtually rendered as 3D objects, as described herein, which may be used as a basis for forming the actual devices via additive manufacturing programing instructions. Thus, the devices may have the precise shapes and sizes of the virtual models. A series of virtual devices according to a treatment plan may be virtually produced using one or more treatment planning programs, and a series of actual/physical devices may be formed (e.g., printed) based on the series of virtual devices.

The arch expanding devices described herein may be made of any of a number of materials. In some examples, the devices are made of one or more polymer materials (e.g., thermoplastic material, nylon, etc.). In some cases, the polymer material(s) may be visible transparent/translucent such that underlying teeth are visible through the polymer material(s). In some cases, the devices are formed of a single type of polymer material, which may be more conducive to some types of additive manufacturing processes. In other cases, the arch expanding devices may be made of more than one type of polymer material. The different types of polymer materials may have different stiffness characteristics, and therefore may be used to make different portions of an arch expanding device. For example, a stiffer polymer material may be used to form at least some of the lingual portion compared to some parts of the tooth engagement portion(s).

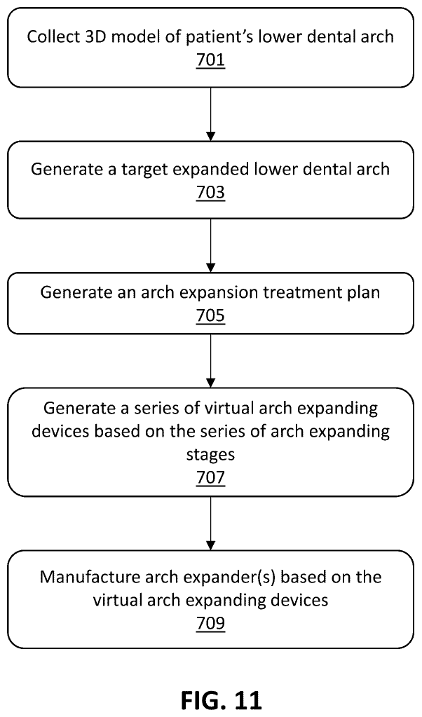

FIG. 11 shows a flowchart indicating an example method for forming a mandibular expander device. A 3D model (e.g., virtual/digital model) of a patient's lower dental arch is collected 701. The 3D model may be based on (e.g., extracted from) one or more dental scans inside the patient's mouth. A 3D model of a target expanded lower dental arch is generated 703. The target lower dental arch has a desired tooth configuration in which the lower arch has a desired arch width and/or arch length. For example, the target lower dental arch may widen and/or lengthen the lower arch to make room for erupting permanent teeth or to un-crowd crowded teeth. These target lower dental arch may also align the teeth of the lower arch with teeth of the upper arch. In some cases, expansion of the upper dental arch is made in conjunction with expansion of the lower dental arch.

An arch expansion treatment plan may be generated 705. This may involve determining expansion forces applied to the lower dental arch necessary to achieve the target lower dental arch. A direction and magnitude of expansion forces applied to the teeth may be calculated based on simulating the expansion forces on the virtual model of the lower arch. The treatment plan may include a series of arch expanding stages in which expansion forces are incrementally applied to the lower arch toward the target arch configuration. In some examples, in addition to expanding the lower dental arch, the arch expansion treatment plan may include straightened teeth to align the position/orientation of the teeth with respect to each other and the lower dental arch. Steps 703 and 705 may be interchanged.

At 707, a series of virtual arch expanding devices are generated based on the series of arch expanding stages of the treatment plan. For example, each of the arch expanding stages may be associated with a corresponding arch expanding device that is configured to apply the necessary forces on the teeth in a configuration at the beginning of a particular stage of the treatment plan toward a configuration at the end of the particular stage. At 709, one or more arch expanding devices is/are manufactured based one or more of the virtual arch expanding devices. In some examples, the arch expanding device(s) is/are fabricated using additive manufacturing based on the virtual version (e.g., 3D model) of the arch expanding device(s).

Methods of treatment planning, including forming and using one or more dental appliances (e.g., a series of lower arch expander apparatuses) may be performed using software, hardware and/or firmware. These procedures may be performed as part of a treatment planning software or may be a separate module (remote or local module) or tool (e.g., lower arch expander planning tool) that may be accessed by (or may receive input from) a treatment planning tool.

FIG. 12 is a diagram showing an example system for forming a lower dental arch expansion appliance. A lower dental arch expansion tool 800 may be incorporated into a portion of one or more treatment planning systems (e.g., arch expansion planning system and/or tooth alignment planning system) and may therefore also be referred to as a sub-system. In some cases, the lower dental arch expansion tool 800 may be an add-on (e.g., plug-in) to one or more treatment planning systems. In any of the methods and apparatuses described herein the lower dental arch expansion tool 800 may be invoked by a user control, such as a tab, button, etc., as part of a treatment planning system, or may be separately invoked. In FIG. 12, the lower dental arch expansion tool 800 may include engines and datastores. As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. The lower dental arch expansion tool 800 may include or be part of a computer-readable medium and may include an input engine 802 that allows access to data related to a patient and/or a library of data. Such data may include a patient's dental scan data and/or 3D models related to a patient's treatment plan. All or some of the data may be stored in one or more datastores 814.

In any of these methods and apparatuses (e.g., systems), a computer system can be implemented as an engine, as part of an engine or through multiple engines. As used herein, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors, or a first engine and a second engine can share one or more processors with one another or other engines. Depending upon implementation-specific or other considerations, an engine can be centralized, or its functionality distributed. An engine can include hardware, firmware, or software embodied in a computer-readable medium for execution by the processor. The processor transforms data into new data using implemented data structures and methods, such as is described with reference to the figures herein.

The engines described herein, or the engines through which the systems and devices described herein can be implemented, can be cloud-based engines. As used herein, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

The lower dental arch expansion tool 800 may include a computer-readable medium. The modules/engines may be coupled to one another (e.g., example couplings are shown in FIG. 12 by the interconnecting lines) or to modules/engines not explicitly shown in FIG. 12. The computer-readable medium may include any computer-readable medium, including without limitation, a bus, a wired network, a wireless network, or some combination thereof. The engine described herein may implement one or more automated agents, including machine learning agents.

As used herein, datastores 814 are intended to include repositories having any applicable organization of data, including tables, comma-separated values (CSV) files, traditional databases (e.g., SQL), or other applicable known or convenient organizational formats. Datastores 1016 can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described herein.

The datastores 814 may include data structures. As used herein, a data structure is associated with a particular way of storing and organizing data in a computer so that it can be used efficiently within a given context. Data structures are generally based on the ability of a computer to fetch and store data at any place in its memory, specified by an address, e.g., a string of bits that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores 814, described herein, can be cloud-based datastores. A cloud-based datastore is a datastore that is compatible with cloud-based computing systems and engines.

An arch expansion engine 804 may calculate expansion forces for expanding the lower dental arch based on the patient's current lower dental arch (e.g., based on the oral scan(s)) and a target lower dental arch. As described herein, the target lower dental arch configuration generally has a longer and/or wider arch than the patient's current condition. The expansion forces may be calculated based on applying outward forces on lingual sides of one or more of the teeth. The arch expansion engine 804 may determine the direction and magnitude of forces applied to each of the teeth to achieve the target lower dental arch configuration.

As mentioned above, in general any of these methods and apparatuses may include alignment of the teeth while expanding, and/or preventing or limiting tipping. Thus, the methods and apparatuses, including treatment planning software, described herein may be configured to move teeth in addition to expanding the lower arch. In general, expansion and/or movement of the lower jaw may result in movement of the teeth relative to the upper jaw (although in some cases the upper jaw may be expanded and moved concurrently with expansion of the lower jaw). In any of these methods and apparatuses, the software may be configured to account for movement of the teeth of the lower jaw during expansion of the lower jaw, relative to the upper jaw. Thus, in some of these examples, the method may modify the position of one or more teeth on an upper jaw, and/or may modify the occlusal surface of the upper jaw so that the bite between the upper and lower jaws is minimally impacted (if at all) during treatment with the lower jaw expander.

A tooth alignment engine 806 may optionally be used to manage aspects related to the repositioning of one or more teeth for alignment purposes. The tooth alignment engine 806 may be configured to consider the arch expanding forces and calculate additional forces on the teeth to align and straighten the teeth. The tooth alignment forces may be applied to buccal, labial, lingual and/or occlusal sides of one or more teeth of the lower dental arch.

A treatment planning engine 808 may determine an integrated treatment plan based on the patient's current lower arch configuration (e.g., prior to treatment) and the target lower arch configuration (e.g., desired final tooth configuration). The treatment planning engine 808 may integrate the arch expansion forces determined by the arch expansion engine 804, and in some cases the tooth alignment forces determined by the tooth alignment engine 806, to generate a plan that achieves the target lower arch configuration in a stepwise fashion through multiple stages. The treatment planning engine 808 may be configured to generate intermediate dentition models corresponding to intermediate stages of the treatment plan.

An arch expansion device engine 810 may be configured to generate one or more virtual arch expansion device models that are configured to apply the arch expansion forces (and in some cases also tooth alignment forces) to the tooth/teeth in accordance with the stages of the arch expansion treatment plan. In some cases, the arch expansion device models may be virtually placed on models of the patient's lower dental arch to assure proper fit. The arch expansion device engine 810 may be used to modify the expansion device models, for example, by changing a shape of certain portions of the expansion device models. For example, the expansion device models may be changed to modify the arch expanding forces and/or to achieve desired comfort for the patient.

An output engine 812 may be configured to generate one or more outputs, such data for manufacturing the arch expansion device(s). The output engine 812 may access data stored in the datastore 814, such as 3D model data for the arch expansion device(s). In some cases, the output includes virtual 3D models of the arch expansion device(s) in a format that is readable by an additive manufacturing machine (e.g., 3D printer) to fabricate physical arch expansion device(s). In some cases, the output may include instructions fabricating the arch expansion device(s). In some cases, the output may be in a format suitable for forming the arch expansion device(s), or a portion thereof, using one or more manufacturing processes other than additive manufacturing, such as a molding process or etching process.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A system for expanding a patient's lower dental arch, the system comprising:
a series of expander devices each configured to incrementally expand the patient's lower dental arch toward a desired arch configuration based on a treatment plan, wherein each expander device of the series of expander devices comprises a polymeric shell comprising:
a first tooth-receiving portion shaped to receive one or more first teeth, the first tooth-receiving portion having a first lingual side, a first buccal side and a first occlusal side;
a second tooth-receiving portion shaped to receive one or more second teeth, the second tooth-receiving portion having a second lingual side, a second buccal side and a second occlusal side; and
a bridge region coupling the first lingual side to the second lingual side, wherein the bridge region is configured to maintain an expansion width between the first lingual side and the second lingual side that applies an expansion force between the one or more first teeth and the one or more second teeth when the device is worn on a patient's lower dental arch to expand the patient's lower dental arch, wherein the first lingual side and the second lingual side are configured to transmit all or some of the expansion force;
further wherein the expansion widths of the expander devices in the series of expander devices increase over a course of the series.

2. The system of claim 1, wherein the first and second lingual sides are stiffer than the first and second buccal sides or the first and second occlusal sides.

3. The system of claim 1, wherein the first and second lingual sides are thicker than the first and second occlusal sides or the first and second buccal sides.

4. The system of claim 1, wherein the polymeric shell of each expander device is made of a single polymer material.

5. The system of claim 1, wherein the width between the first lingual side and the second lingual side of each subsequent expander device of the series of expander devices is wider than a previous expander device in the series.

6. The system of claim 1, wherein each expander device of the series of expander devices is configured to apply the expansion forces with a magnitude and direction in accordance with a stage of an arch expansion treatment plan.

7. The system of claim 1, wherein the expansion force of each expander device of the series of expander devices is between 1 Newton (N) and 25 N.

8. The system of claim 1, wherein the bridge region of at least one of the expander devices of the series of expander devices is configured to contact one or more anterior teeth when the device is worn on the patient's lower dental arch.

9. The system of claim 8, wherein the bridge region of at least one of the expander devices of the series of expander devices is configured to apply a second expansion force on the one or more anterior teeth.

10. The system of claim 1, wherein the first lingual side is thicker than the first buccal side, and the second lingual side is thicker than the second buccal side for each of the expander devices of the series of expander devices.

11. The system of claim 1, wherein the first tooth-receiving portion and the second tooth-receiving portion for each of the expander devices of the series of expander devices are shaped to receive only molars, premolars, or molars and premolars.

12. The system of claim 1, wherein the bridge region is configured to conform to a lingual surface of the patient's lower dental arch when the device is worn by the patient.

13. The system of claim 1, wherein the bridge region is configured to conform to a lingual surface of one or more anterior teeth when the device is worn by the patient.

14. The system of claim 1, wherein the bridge region comprises a tooth-receiving portion having one or more of: a buccal side, a lingual side and an occlusal side.

15. The system of claim 1, wherein the bridge region for at least one of the expander devices of the series of expander devices includes one or more openings that are arranged to allow exfoliation of one or more primary teeth of the patient's lower dental arch.

16. The system of claim 1, wherein each expander device includes a plurality of attachment cavities, each configured to couple to an attachment bonded to one or more of the patient's teeth.

17. The system of claim 1, further comprising one or more bite adjustment structures that are configured to promote mandibular advancement, wherein the one or more bite adjustment structures are shaped and arranged to contact the patient's upper dental arch or a dental device on the patient's upper dental arch.

18. The system of claim 17, wherein the one or more bite adjustment structures are shaped and arranged to contact corresponding one or more bite adjustment structures of the dental device on the patient's upper dental arch.

19. The system of claim 1, wherein one or both of the first occlusal side and the second occlusal side for at least one of the expander devices of the series of expander devices has a thickness configured to disocclude anterior teeth of the patient's lower dental arch.

20.-45. (canceled)

46. A system for expanding a patient's lower dental arch, the system comprising:
a series of expander devices each configured to incrementally expand the patient's lower dental arch toward a desired arch configuration based on a treatment plan, wherein each expander device of the series of expander devices comprises a polymer shell comprising:
at least one tooth-receiving portion shaped to receive one or more first teeth of a first side of a patient's lower dental arch, the at least one tooth-receiving portion including a buccal side and an occlusal side;
a lingual portion coupled to the at least one tooth-receiving portion and arranged to contact lingual surfaces of one or more second teeth on an opposite side of the patient's lower dental arch when the device is worn on the patient's lower dental arch; and
a bridge portion shaped and sized to transmit an arch expanding force to the lingual portion in accordance with a corresponding stage of the treatment plan.

47.-50. (canceled)

51. A system for expanding a patient's lower dental arch, the system comprising:
a series of expander devices each configured to incrementally expand the patient's lower dental arch toward a desired arch configuration based on a treatment plan, wherein each expander device of the series of expander devices comprises a polymeric shell comprising:
a polymer shell defining a plurality of tooth-receiving cavities shaped to receive a plurality of teeth of a patient's lower dental arch, the polymer shell having a lingual side, a buccal side, and an occlusal side, wherein:
the plurality of tooth-receiving cavities is shaped to apply tooth aligning forces to straighten one or more of the plurality of teeth in accordance with a stage of a treatment plan when the polymer shell is worn on the patient's lower dental arch; and
at least a portion of the lingual side is stiffer than the buccal side or the occlusal side of the plurality of tooth-receiving cavities and has an expansion width, wherein the lingual side is configured to apply an expansion force between opposing teeth in accordance with the stage of the treatment plan when the polymer shell is worn on the patient's lower dental arch,
further wherein the expansion widths of the expander devices in the series of expander devices increase over a course of the series.

52.-83. (canceled)
